(19) United States
(12) Patent Application Publication
(10) Pub. No.: US 2014/0117257 A1
(43) Pub. Date: May 1, 2014

(54) FACILITY FOR EXPOSING PHOTOPOLYMER PLATES

(71) Applicant: Denis Bertrand, Chavigny (FR)

(72) Inventor: Denis Bertrand, Chavigny (FR)

(73) Assignee: PHOTOMECA FRANCE, Champigneulles (FR)

(21) Appl. No.: 14/129,627

(22) PCT Filed: Jul. 4, 2012
(86) PCT No.: PCT/FR2012/051559

§ 371 Date: Dec. 27, 2013

(30) Foreign Application Priority Data
Jul. 11, 2011 (FR) 1156284

(51) Int. Cl. G21K 5/00

(52) U.S. Cl. CPC G21K 5/00
USPC 250/492.1

(57) ABSTRACT

A device for emitting ultraviolet light configured such as to expose a photopolymer plate, in particular for flexographic printing, includes a main row of lamps in the form of equidistant ultraviolet light tubes, separated from one another by a space. An additional source of ultraviolet light is located outside of the plane of said main row of lamps. Said additional source of ultraviolet light is configured such as to send beams of ultraviolet light through said spaces between the lamps of said main row. An exposure facility is also disclosed, which includes a device as described above, as well as to a method for exposing a photopolymer plate using a the device.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to the exposure of printing plates.

The present invention essentially proposes an improved machine for exposing photopolymer plates for flexographic printing.

2. Description of Related Art Including Information Disclosed Under 37 CFR 1.97 and 37 CFR 1.98

Machines for exposing photopolymer plates using an ultraviolet light source have already been proposed.

As a general rule, a machine of this type comprises a frame above which an array of ultraviolet lamps is placed.

A photopolymer plate is placed on the upper part of the frame, under the array of ultraviolet lamps, and is exposed by the lamps through a negative film positioned on the plate. The film and plate assembly is kept under a vacuum on the upper part of the machine frame by means of a transparent membrane.

EP1349004 discloses an alternative, in which the negative film is replaced by an ink jet impression, to avoid the need for a vacuum. Other alternatives have been proposed with the negative formed by a layer of carbon on the plate. However, the result appears to be insufficiently precise in this type of solution, unless the vacuum, or at least an absence of oxygen, is maintained above the plate. This is achieved either by using a film held above the plate, or by flushing with inert gas.

This constraint makes it necessary to increase the power of the ultraviolet radiation for printing the plate. However, conventional lamps cannot provide a power of more than 18 mW/cm². This value is achieved by optimizing the distance between the lamps and the plate, so as to minimize the differences in power received at different points of the plate, notably at points facing a lamp and at those facing a space between two lamps. In order to achieve sufficient quality, a power of 20 mW/cm² would be required.

EP1316847 discloses an ultraviolet printing machine comprising, a monitoring means for each tube, enabling a tube to be replaced as soon as its power decreases below a threshold value. This makes it possible to avoid operating with faulty lamps. However, it does not allow the power to be increased above approximately 18 mW/cm².

### SUMMARY OF THE INVENTION

The object of the present invention is to overcome these drawbacks, at least partially, To this end it proposes a device for emitting ultraviolet light, configured to expose a photopolymer plate, particularly for flexographic printing, comprising a main row of lamps in the form of equidistant ultraviolet light tubes, separated from one another by a space. The device is distinctive in that it includes an additional ultraviolet light source located outside the plane of said row of lamps, configured to send beams of ultraviolet light through said spaces between the lamps of said row.

Because of these arrangements, the additional source serves to increase the power at points facing the spaces between two lamps of the main row. By means of inclined beams, it can also act on points facing the lamps, thus adding exposure power to the power delivered by the main row of lamps. According to other characteristics,
said additional ultraviolet light source is formed by a secondary row of lamps, in the form of ultraviolet light tubes, thus enabling the invention to be applied by using only standard UV light sources available on the market,
the distance between the main row and the secondary row of lamps is greater, preferably by a factor of about two, than the distance between two lamps in the main row; with this arrangement it is possible to make each tube of the secondary row send not only a main beam which is practically perpendicular to the plate, but also at least one secondary beam to the far side of one of the tubes located immediately below it,
the lamps of the secondary row are substantially identical to the lamps of the main row, and are separated by a substantially identical space,
the position of the lamps of the secondary row of lamps, projecting vertically when this row is positioned horizontally, is offset with respect to the midpoint between two lamps of the maw row of lamps, this arrangement providing a distribution of the main and secondary beams emitted by the lamps of the secondary row such that optimal compensation is provided for the areas least illuminated by the main row.

The present invention also relates to a facility for exposing photopolymer plates, particularly for flexographic printing, comprising a frame above which is located a hood comprising a device according to the invention for exposing a photopolymer plate resting on said frame.

Finally, the present invention relates to a method for exposing photopolymer plates, particularly for flexographic priming, by means of a facility according to the invention, in which, during exposure, the distance between the main row of lamps, measured at the height of said tubes, and said plate is substantially identical to the distance between two lamps of said main row of lamps.

The present invention has the advantage of proposing a facility for exposing a photopolymer plate which uses standard UV radiation tubes available on the market, and which can be used to provide, at every point of the plate, an exposure power considerably greater than the 20 mW/cm² required for the use of new vacuumless techniques.

### BRIEF DESCRIPTION OF THE SEVERAL VIEWS OF THE DRAWINGS

The present invention will be more clearly understood from a perusal of the following detailed description, provided with reference to the attached figures, in which:

FIG. 1 shows a perspective view of a facility according to the invention,

FIG. 2 is a schematic view of the arrangement of the tubes of the facility of FIG. 1.

### DETAILED DESCRIPTION OF THE INVENTION

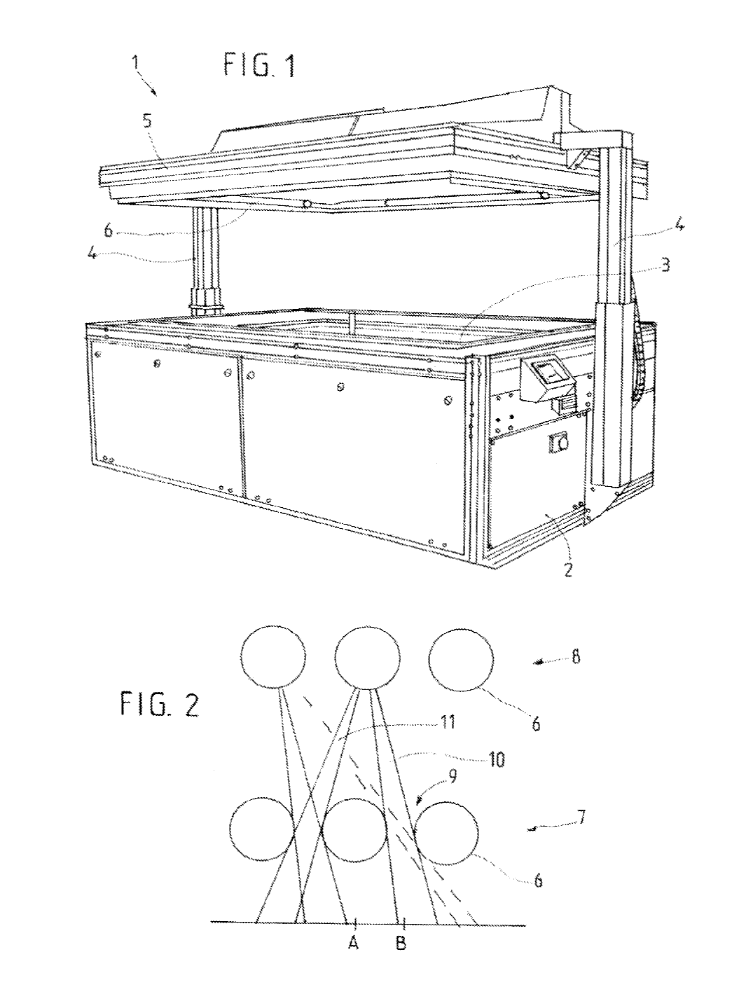

As shown in FIGS. 1 and 2, a facility 1 according to the invention comprises a frame 2 adapted to receive a photopolymer plate 3 in a horizontal position. Two adjustable vertical pistons 4 hold a hood 5 comprising lamps 6 in the form of ultraviolet light tubes. These lamps 6 are positioned in a main row 7 and a secondary row 8 of lamps. Each row is therefore composed of lamps 6 separated by spaces 9. Typically, the lamps 6 have a diameter of 40 mm, and the spaces 9 are about 10 mm, providing an interval of 50 mm between two successive lamps in the row. In the following text and throughout the present application, this interval is called “the distance between two lamps”. The lamps have a length of about 1750 mm, allowing them to be fitted into a frame 2 which is about 2 m wide. For example, this frame 2 may be made with a length of 3 m, and may be fitted with a row of lamps 6 comprising about fifty lamps.

The lamps 6 of the main row 7 emit rays of ultra violet light (or UV rays) toward the plate 3. Clearly, the points of the plate 3 facing a tube receive the UV beam from the tube in a perpendicular manner, and therefore receive more power from this tube than the other points. The expression “facing” is to be understood in the context of the present application as having a vertical projection onto the plate 3, winch is in a horizontal position.

However, each point also receives inclined beams from the neighboring lamps, at a lower power, partly because of the inclination of the beam and partly because of the distance to the emitting tube. For the exposure of the plate 3, all the points of the plate 3 must receive a minimum of exposure power. The distribution of power over the plate 3 must therefore be examined, and the requisite minimum power most be provided at each point. In prior art facilities, the distance between the main row 7 of lamps 6 and the plate 3 is adjusted to at least 1.5 times the distance between two tubes of said row, and therefore to about 75 mm in the example given above. This distance is to be interpreted as the distance between the surface of the plate 3 and the axes of the ultraviolet light tubes forming the lamps 6. These axes are all located, in the same horizontal plane in a situation in which a horizontally positioned plate 3 is exposed. The distance is therefore the same for any tube of the main row 7. This distance of 75 mm enables each point of the plate 3 to receive the UV rays from at least three tubes, thus providing a relatively uniform distribution of the power of the UV rays over the surface of the plate 3. Greater distances are also possible.

Each of the lamps has an electrical power of 100 W and emits UV rays with a power of about 26 W, With the distribution described above, it is observed that the minimum power received by the plate 3 is about 18 mW/cm² with new lamps 6, and this power decreases to 15 or 16 mW/cm² before the lamps can be replaced, this replacement being programmed so as to achieve the best compromise between the exposure power and the replacement cost of the lamps 6.

With a shorter distance, 50 mm for example, the points of the plate 3 facing a lamp 6 receive a higher power, well above 20 mW/cm², whereas the points facing a space 9 receive a lower power of less than 16 mW/cm², and the guaranteed minimum power is therefore measured at these points and is found to be lower overall than at the distance of 75 mm.

According to the invention, the presence of a secondary row 8 of lamps 6, adapted to expose the plate by means of beams 10, 11 passing through the spaces 9 between lamps of the main row 7 of lamps 6, eliminates the need to provide a uniform distribution of the exposure by the main row 7, since the secondary row 8 is provided to expose points that have received little exposure from the main row 7.

The main row 7 is then brought toward the plate 3, to a distance substantially equal to the distance between two lamps of said row, and therefore to about 50 mm in the example above. Thus each point of the plate 3 receives the UV rays of less than three lamps, and the power received is significantly higher at a point A facing a tube than at a point B facing the space 9 between two lamps 6 (see FIG. 2).

According to the invention, a secondary row 8 of lamps 6 is positioned above the main row 7. This secondary row 8 emits UV rays toward the plate 3, but these rays can only reach the plate 3 by passing through the spaces 9 between the lamps 6 of the main row 7. This arrangement therefore enables the exposure power to be supplemented where it is insufficient. By supplementing the power in this way, a more significant minimum guaranteed power can be provided. It also provides a choice of positions of the main row 7, enabling this minimum guaranteed power to be increased further.

Measurements were made on a facility 1 according to the invention, using the same lamps 6 as above. The distance between the two rows of lamps 6 was 10 cm, and the horizontal offset of the secondary row 8 of lamps 6 was 1 cm with respect to the midpoint between two lamps 6 of the main row 7.

A minimum UV exposure power of 24 mW/cm² was obtained, with a maximum of more than 27 mW/cm².

By means of the arrangement according to the invention, therefore, it is possible to meet the requirement to achieve at least 20 mW/cm² at every point of the plate 3, while having an ample margin to allow for the ageing of the lamps 6, so that the life of these lamps 6 can be lengthened.

The secondary row 8 is located above the main row 7 at a distance greater than the distance between two lamps 6 of the main row 7, preferably at a distance of about twice the distance between two lamps 6. In fact, it has been found beneficial to place the secondary row 8 high enough for each tube to send UV rays through at least two gaps between two lamps 6 of the main row 7.

The distances are given here simply by way of example, and shorter or longer distances may also be used without departing from the scope of the present invention.

Various tests have also shown that the optimal position of the secondary row 8 is not the position in which each of its lamps 6 faces the midpoint of the space 9 between two lamps 6 of the main row 7. This position would allow each tube of the secondary row 8 to send a main beam 10 through a gap between the two lamps 6 of the main row 7 located immediately below, and two secondary symmetrical beams 11, one on each side of these two lamps 6. If the lamps 6 of the secondary row 8 are offset, to the left for example (FIG. 2), the main beam 10 is only slightly affected, while the secondary beam 11 emitted toward the left is markedly strengthened, but the beam emitted toward the right becomes almost insignificant. It has been found that this improves the result in terms of the minimum power at each point of the plate 3, since this arrangement provides better compensation for the points least subject to exposure by the lamps 6 of the main row 7. This offset toward the left could be replaced by an offset toward the right, or an offset by a greater or lesser amount, or even no offset at all, without departing from the scope of the present invention.

The present invention has the advantage o f proposing a facility 1 for exposing a photopolymer plate 3 which uses standard. UV radiation lamps 6 available on the market, and which can be used to provide, at every point of the plate 3, an exposure power considerably greater than the 20 mW/cm² required for the use of new vacuumless techniques. Furthermore, the higher power enables the exposure time to be reduced. It has been found that the exposure time determines the manufacturing cycle time in many industrial facilities. In fact, exposure typically takes 20 minutes. After exposure, the plate 3 must be sent for etching, which takes 10 minutes, and then to a drying oven for 1 hour 30 minutes. However, the oven can easily contain a plurality of plates 3 arriving in succession, and therefore this time does not affect the overall cycle time. Finally, on leaving the oven, the plate 3 is subjected to a second, briefer, exposure in the form of UVC light finishing to make the plate 3 less adhesive, and UVA post-exposure for about 10 minutes. It therefore appears that, if the initial exposure time can be reduced, to 10 or 12 minutes for example, by providing a guaranteed minimum power of 28 mW/cm², reduced after ageing to 26 mW/cm², the speed of the whole production line can be increased, thus immediately improving the production costs. The present invention can significantly increase the exposure power, and therefore it follows that the exposure time can be reduced.

In some applications, it is also helpful to add an array of lamps 6 in the frame 2 under the plate 3 to be exposed. Clearly, this arrangement can be provided with a facility 1 according to the invention, in the same way as in the prior art.

Although the invention has been described with reference to a specific embodiment, it is not in any way limited thereby, and variants thereof may be devised, as well as combinations of the described variants, without in any way departing from the scope of the present invention. In particular, the additional UV radiation source may be composed of tubes arranged in ways other than in rows. The distances, notably between the rows of lamps and the plate, may be increased or decreased, without departing from the scope of the present invention.

1. An ultraviolet light emission device configured to expose a photopolymer plate, particularly for flexographic printing, comprising a main row of lamps in the form of equally spaced ultraviolet light tubes, separated from each other by a space, characterized in that it comprises an additional ultraviolet light source located outside the plane of said main row of lamps, said additional ultraviolet light source being configured to send beams of ultraviolet light through said spaces between the lamps of said main row.

2. The device as claimed in claim 1, wherein said additional ultraviolet light source is formed by a secondary row of lamps, in the form of ultraviolet light tubes.

3. The device as claimed in claim 2, wherein the distance between the main row and the secondary row of lamps is greater, preferably by a factor of about two than the distance between two adjacent lamps of the main row.

4. The device as claimed in claim 2, wherein the lamps of the secondary row are substantially identical to the lamps of the main row, and are separated by a substantially identical space.

5. The device as claimed in claim 4, wherein the position of the lamps of the secondary row of lamps, projecting vertically when this row is positioned horizontally, is offset with respect to the midpoint between two lamps of the main row.

6. A facility for exposing photopolymer plates, particularly for flexographic printing, comprising a frame above which is located a hood comprising a device as claimed in claim 1, adapted to expose a photopolymer plate resting on said frame.

7. A method for exposing photopolymer plates, particularly for flexographic printing, using a facility as claimed in claim 1, characterized in that, during exposure, the distance between the main row of lamps, measured at the level of the axes of said tubes, and said plate is substantially identical to the distance between two lamps of said main row.
